(19) United States
(12) Patent Application Publication
(10) Pub. No.: US 2009/0191849 A1
(43) Pub. Date: Jul. 30, 2009

(54) ENHANCED MESSAGING COLLABORATION

(75) Inventors: Giuseppe Fioretti, Rome (IT); Sandro Piccinini, Rome (IT); Luigi Pichetti, Rome (IT); Marco Secchi, Rome (IT)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: International Business Machines Corporation, Armonk, NY (US)

(21) Appl. No.: 12/356,374

(22) Filed: Jan. 20, 2009

(30) Foreign Application Priority Data
Jan. 28, 2008 (EP) 08100988.8

(51) Int. Cl. H04M 3/00; H04B 7/00

(52) U.S. Cl. 455/412.2; 455/41.2

(57) ABSTRACT

The capabilities of a collaboration messaging system are extended through so that a user can be contacted, or at least notified of incoming messages, when the user is away from his own messaging client computer but is near another messaging client computer. The proximity of a user to a messaging client computer other than his own is inferred from the detection of a wireless communications device (e.g., a Bluetooth-enabled cellular phone) associated to the user. The association is recorded in a user profile set up by the user and stored in the collaboration messaging system. If a wireless communications device is detected proximate to a messaging client computer, a search is made of stored user profiles, each of which associates a particular wireless communication with a particular user. If a profile exists for the detected wireless communication device, it is retrieved and a set of actions defined in the user profile is implemented. The defined actions include sending messages addressed to the users own messaging client computer to the proximate messaging client computer, sending notices of the messages to the proximate client computer and sending a notice to the sender of the message that the user is near a particular client messaging computer.

### BACKGROUND

The present invention relates to enhanced messaging collaboration.

Many people today use messaging collaboration systems (e.g. IBM® Lotus® Sametime®, Microsoft® Messenger™, etc.) to exchange information in an easy and immediate way. However, with current systems, it isn't possible to collaborate with a user unless the user is working with his own personal devices at the time, even if the user has access to other users' systems that support the same messaging system(s) normally used by the first user. For example, if user A is in user B's office, user A cannot be notified of incoming messages on his system, nor can user A interact with anyone even if user B uses the same collaboration system and is connected to the network.

### SUMMARY

The invention may be implemented as a computer method for enhancing for enhancing message collaboration by users of a computer messaging collaboration system of the type including client devices associated with individual users and one or more servers. The system includes a system memory for storing user profiles. Each user profile identifies the user profile owner and at least one mobile communications device associated to the owner. The proximity of a detected mobile communications devices to a client device is reported. The identity of a mobile communications device is used to search for a stored user profile including the detected mobile communications device. If such a user profile is located, it is retrieved and used in performing a predetermined operation.

The invention may also be implemented as a computer program product for enhancing message collaboration by users of a messaging collaboration system. The computer program product includes a computer usable medium embodying computer usable program code. The embodied code includes code configured to store, in computer memory, one or more user profiles, each profile identifying a user profile owner and specifying at least one mobile communications device associated to the owner, code configured to receive a report of the detection of the proximity of a mobile communication device to a client device, code configured to use the identity of said mobile communication device to determine whether a stored user profile exists specifying the detected mobile communications device, and code configured, responsive to a determination that a stored user profile exists specifying the detected mobile communications device, to retrieve the user profile and perform a predetermined action in accordance with the retrieved user profile.

Finally, the invention may be implemented as an enhanced message collaboration system including client devices associated with individual users, at least one server, system memory for storing one or more user profiles, each identifying a user profile owner and at least one mobile communications device associated to the owner. The system further includes a device for receiving a report from a mobile communications device detector that has detected the proximity of a mobile communications device to a client device, a search module for determining whether a user profile exists in system memory specifying the detected mobile communications device, and a control module for retrieving a user profile when one is found and performing a predetermined action in accordance with the retrieved user profile.

### BRIEF DESCRIPTION OF THE SEVERAL VIEWS OF THE DRAWINGS

FIG. 1 is a block diagram of a scenario in which the preferred embodiment would be used.

FIG. 2 is a basic flow chart of a method that implements the present invention.

FIG. 3 is an architectural block diagram of one embodiment of the present invention.

FIG. 4 is a flow chart of a configuration phase in a method implementing the present invention.

FIG. 5 is a flow chart of a main flow phase in a method implementing the present invention.

FIG. 6 is a flow chart of a first secondary flow that occurs in a method implementing the present invention.

FIG. 7 is a flow chart of another secondary flow that occurs in a method implementing the present invention.

FIG. 8 is a block diagram of a computer on which the present invention can be implemented.

### DETAILED DESCRIPTION

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

Embodiments of the invention leverage the capabilities of WPAN (Wireless Personal Area Network) devices, such as a Bluetooth™-enabled cellular phone, to extend and improve the capability of a messaging collaboration system.

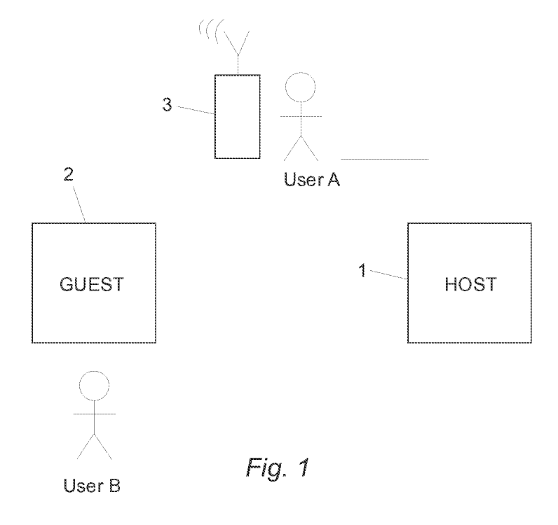

FIG. 1 illustrates a scenario in which a first user (User A) is assumed to “own” (that is, have the right to use) a first computer 1. The first computer 1 runs as a first client of messaging collaboration system and is identified as a “host client” in the following description. It is assumed that User A has temporarily left his own office (and computer 1) and is approaching the office of a User B, who owns a second computer 2 running a second client of the messaging collaboration system. The second client is identified as a “guest client”. It is also assumed User A is carrying an active Bluetooth device. The preferred embodiment enables User A to be contacted in the office of User B (through the guest client) by leveraging the User A's personal Bluetooth device.

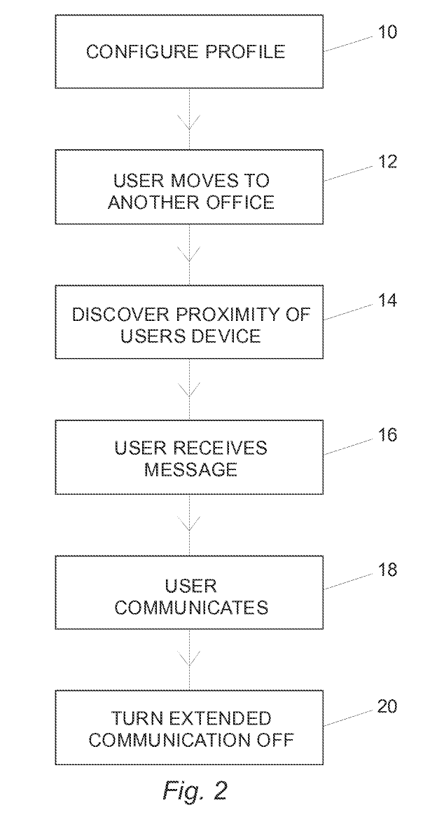

FIG. 2 generally describes events that occur when an implementation of the present invention is put into use. Initially, User A configures (operation 10) a personal profile that enables him to make use of extended communication capabilities. After the personal profile has been configured and recorded in system memory, User A may move (operation 12) toward an office belonging to another user. As User A approaches the office, a client system active in the other user's office will eventually discover (operation 14) user A's Bluetooth device. Assume User A receives (operation 16) a message through his own client while away from his office. While User A is within Bluetooth range of the guest client running in the other user's office, the guest client can provide a capability that allows user A to respond in some way (operation 18) or at least be aware of the message directed to User A's own system. Once User A moves out of Bluetooth range of the guest client, the extended communication capability of the guest client is deactivated (operation 20), at least as to User A.

The following material includes a more detailed description of the architecture of one embodiment, followed by more detailed descriptions of different operational phases of the embodiment. For the sake of example, the embodiment is described within the context of an IBM Lotus Sametime messaging collaboration software system. However, it will be appreciated that the preferred embodiment is not limited to this software system. Instead, the skilled person will understand that the preferred embodiment is operable with any messaging collaboration system.

Similarly, while the embodiment is described in the context of use of a Bluetooth-enabled personal device, it will be appreciated that invention is not limited to use with only Bluetooth-enabled devices. Devices implementing other WPAN (wireless personal area network) protocols (e.g. Zigbee) can be used in implementing the present invention.

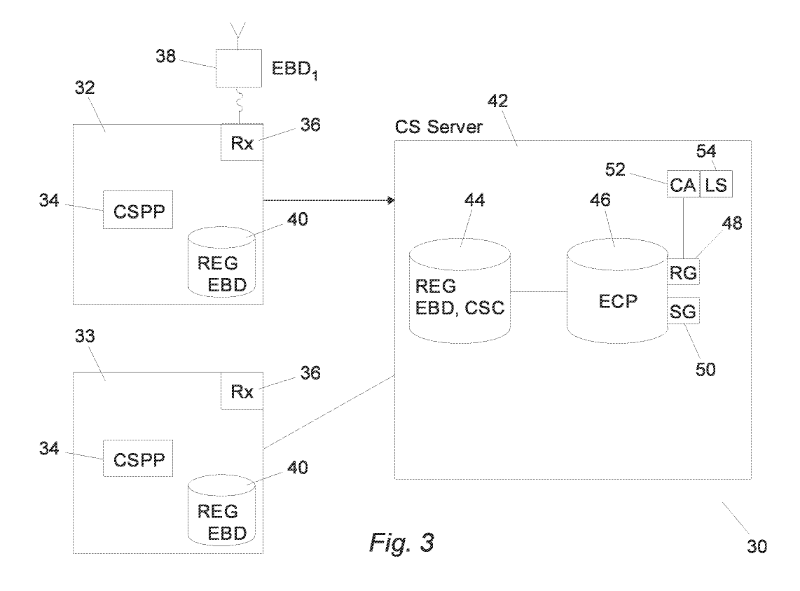

Referring to FIG. 3, the collaboration system 30 includes client devices 32 and 33. referred to more generally as clients. Each of the clients 32 and 33 includes a proximity plug-in 34 which interacts with a Bluetooth-enabled receiver device 36. The proximity plug-in and Bluetooth-enabled receiver device function as a mobile communications device detector that can detect nearby Bluetooth devices, such as device 38. Each of the clients 32 and 33 keeps a record of the detected Bluetooth devices in a registry 40.

The clients 32 and 33 are shown connected to a server 42, but may be connected to other servers (not shown) as well. Server 42 includes a system memory having a first registry 44 of one-to-one associations between Bluetooth devices, such as device 38, and clients, such as clients 32 and 33. More particularly, the first registry 44 specifies the client(s) to which a Bluetooth device is linked. The system memory in server 42 further includes a second registry 46 of extended communication profiles associated with the Bluetooth devices specified in the first registry 44.

The extended communication profiles include a plurality of receiver groups 48 and a sender group 50 for each Bluetooth device 38. The members of a receiver group 48 are clients (such as clients 32 and 33) to which messages or message notices may be sent. Similarly, the members of the sender group 50 are clients (or more particularly, collaboration system accounts) that are enabled to make use of the present invention. If a user is not identified in the sender group, messages will still be delivered to the user's own machine, but neither messages nor message notices will be forwarded to an absent user through other users' systems.

In one embodiment, a maximum of three receiver groups 48 can be configured in an extended communication profile, with each receiver group 48 being associated with a different action 52. In this embodiment, the actions 52 are:

(1) sending a notice to guest client that a detected user in the proximity of the guest client is receiving a message;

(2) routing messages to a guest client where those messages are addressed to a detected user in the proximity of the guest client; and

(3) sending a notice to a message sender that the message addressee has been detected in proximity to an identified guest client.

Levels of security 54 associated with actions 52 specify the information that will be exposed to a current user of a guest client when a Bluetooth device belonging to another nearby user of the collaboration system is detected. As a specific example, the security levels may specify whether or not a handshake is required from the nearby user on his/her Bluetooth device before messaging information will be released to the guest client.

Operations occurring during use of one embodiment of the present invention can be divided into a configuration phase, a main flow and secondary flows. Each of these is described in more detail below.

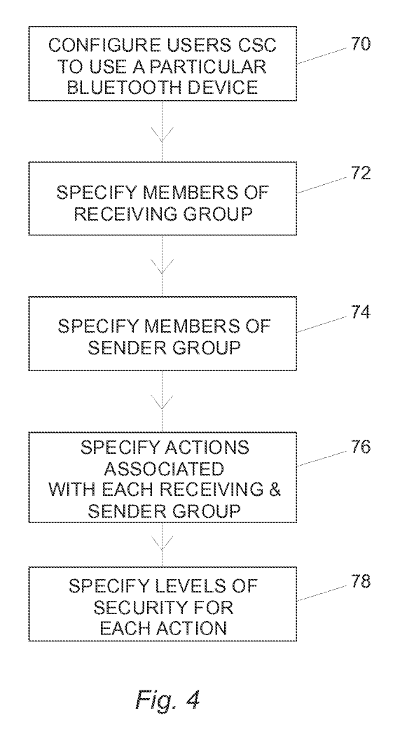

Referring to both FIGS. 3 and 4, during the configuration phase, a user configures (operation 70) his client 32 to recognize a particular personal Bluetooth device. For example, user A configures his client to recognize a Bluetooth cellular phone with id=123YYY. The user then specifies (operation 72) the clients to be included in one or more receiver groups 48 and (operation 74) the clients to be included in one or more sender groups 50. The user then configures (operation 76) the actions associated with a given receiver group 48 and sender group 50. Finally, the user specifies (operation 78) the security requirements associated with the configured actions.

It is possible to define a first receiver group wherein only message notices (and not the messages themselves) are provided to clients. A second receiver group may be configured to permit the messages to be routed to clients included in the receiver group. Finally, a third receiver group may be configured to return a notice to a message sender that a message addressee has been detected in proximity to a client or clients identified in the third receiver group.

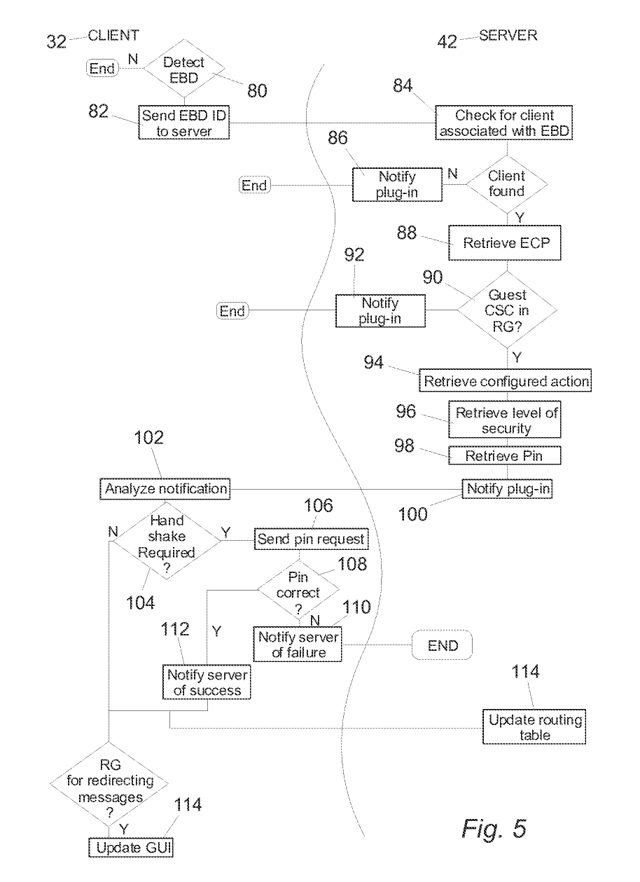

Referring to FIGS. 5 and 3 together, when a Bluetooth receiver device 36 in a client 32 detects (operation 80) the nearby presence of a Bluetooth device 38, the proximity plug-in 34 in the client 32 notifies the server 42 of the event. Furthermore, the proximity plug-in 34 sends (operation 82) the server 42 the identities of the detected Bluetooth device 38 and of the client 32 that detected it. The proximity plug-in 34 then waits for a response from the server 42.

On receipt of a signal from the proximity plug-in 34, a search module in the server 42 searches (operation 84) its first registry 44 for a client 33 associated with the detected Bluetooth device 38. If a client 33 is not found by the server 42, the server 42 notifies (operation 86) the proximity plug-in 34 that it has no record of the detected Bluetooth device 38. On receipt of this notification, the guest client 32 stops processing any signals associated with the detected Bluetooth device 38.

However, if the server 42 finds a client 33 associated with the Bluetooth device 38, a control module in the server 42 interrogates (operation 88) its second registry 46 to retrieve an extended communication profile associated with the client 33. The server 42 then checks whether the guest client 32 is listed in a receiver group 48 of the extended communication profile. If the guest client 32 is not listed in a receiver group 48, the server 42 notifies (operation 92) the proximity plug-in 34 (in the guest client 32) that the guest client 32 is not interested in communicating with the detected external Bluetooth device 38. The proximity plug-in 34 takes no action in response and the flow ends.

If, on the other hand, the guest client 32 is listed in a receiver group 48, the server 42 retrieves (operation 94) the configured action 52 associated with the receiver group 48. The server 42 also retrieves (operations 96 and 98) the level of security 54 associated with the configured action 52 and a security PIN (if required). The server 42 constructs a notification to the proximity plug-in 34 (in the guest client 32), wherein the notification contains the retrieved configured action 52, level of security 54 (and any required security PIN) and an indication that the guest client 32 is interested in implementing an extended communications. The server 42 then sends (operation 100) the notification to the proximity plug-in 34.

On receipt of the notification, the proximity plug-in 34 analyzes (operation 102) the notification to determine the level of security 54 required for subsequent communications. If the level of security 54 specifies that a handshake is required (operation 104), the proximity plug-in 34 sends (operation 106) a PIN request to the detected Bluetooth device 38 and waits for a response. If the requested PIN is invalid (operation 108) or not received before the expiry of a pre-defined time-out period, the proximity plug-in 34 notifies (operation 110) the server 42 that the Bluetooth communication has not been acknowledged for the guest client 32. The data flow then ends. However, if a valid PIN is received (operation 108), the proximity plug-in 34 notifies (operation 112) the server 42 that the Bluetooth extended communication has been acknowledged for the guest client 32. It should be noted that if security handshaking is not required (operation 104) from the external Bluetooth device 38, the proximity plug-in 34 takes no action and the data flow proceeds.

At this point, the server 42 updates (operation 114) its routing tables in order to:

(a) redirect messages addressed to the host client 33, (i.e. running on User A's computer) to the guest client 32, if the guest client 32 is a member of the receiver group 48 associated with a configured action 52 for routing messages;

(b) forward a message notification to the guest client 32 when a message is received by the host client 33 if the guest client 32 is a member of the receiver group 48 associated with a configured action 52 for forwarding notifications; and

(c) send a message to a message sender client (every time a message is received by the host client 33), advising them that the intended recipient (i.e. User A) is in proximity to the guest client 32.

If the notification received by the proximity plug-in 34 indicates that the guest client 32 is a member of a receiver group 48 associated with a configured action 52 for redirecting messages, the proximity plug-in 34 updates (operation 114) the guest client user interface to allow the choice of client identity (host or guest) with which to send messages. It should be noted that such choice is only possible when the message targets are clients within the designated sender group.

Secondary flows manage the following events:

(1) messaging to the host client 32;

(2) messaging from the guest client 33 on behalf of the host client 32; and

(3) movement of the external Bluetooth device out of range of the Bluetooth receiver device in a guest client.

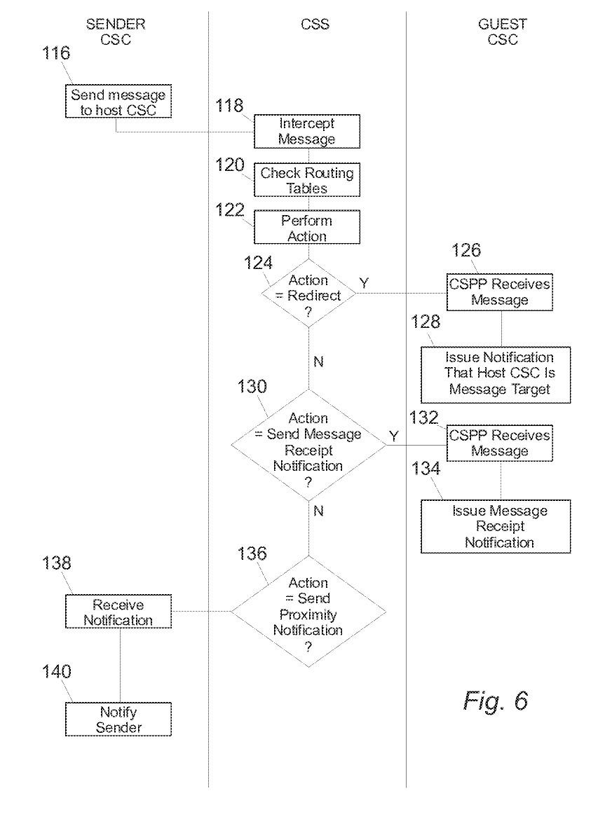

Referring to FIG. 6, a client in the sender group sends (operation 116) a message to the host client. The message is received by the server, which consults (operation 120) its message routing tables to route the message to the client. The message routing tables indicate one of the following actions:

(a) redirect the message to the guest client, adding the host client as message target;

(b) send a message receipt notification to the guest client while tracking the notification to make sure no additional notifications are sent to the guest client for further messages from the same sender client; and

(c) send back a host client-to-guest client proximity notification to the sender client. The server performs (operation 122) one of the actions listed in the routing tables.

If the server redirects (operation 124) the message to the guest client, the proximity plug-in receives (operation 126) the message and causes the guest client to issue (operation 128) a notification that the host client was the intended target for the message. Similarly, if the server sends (operation 130) a message receipt notification to the guest client, the proximity plug-in receives (operation 132) the message-receipt notification and makes the host client issue (operation 134) it. The flow then ends.

Furthermore, if the server returns (operation 136) a host client-to-guest client proximity notification to the sender client, the sender client receives (operation 138) the proximity notification and notifies (operation 140) the sender of the same.

User A with host client account performs one of the two following actions:

(i) responds to a message for his/her account redirected to the guest client; or

(ii) sends a message from the guest client selecting the host client (his/her account) as the message sender.

Before the guest client sends the message to the server, the proximity plug-in overrides the message sender account (changes the default account of the host client with the account of the guest client). The server receives the message and routes it to the receiver client. The receiver client receives the message. The flow ends.

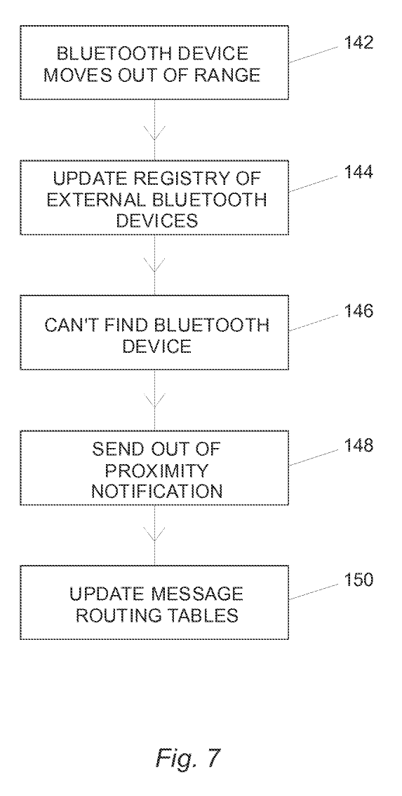

Referring to FIG. 7, assume User A's external Bluetooth device moves (operation 142) out of range of a Bluetooth receiver device in a guest client computer. The operating system of the guest client computer updates (operation 144) the registry of external Bluetooth devices. As a result, the proximity plug-in (which periodically browses the registry of external Bluetooth devices detected by the Bluetooth receiver device of the guest client computer) can no longer find (operation 146) the identity of User A's Bluetooth device. The proximity plug-in sends (operation 148) host client-to-guest client “out of proximity” notification to the server, including the guest client identity and the host client identity.

The server receives such notification and updates (operation 150) its message routing tables, restoring the default settings.

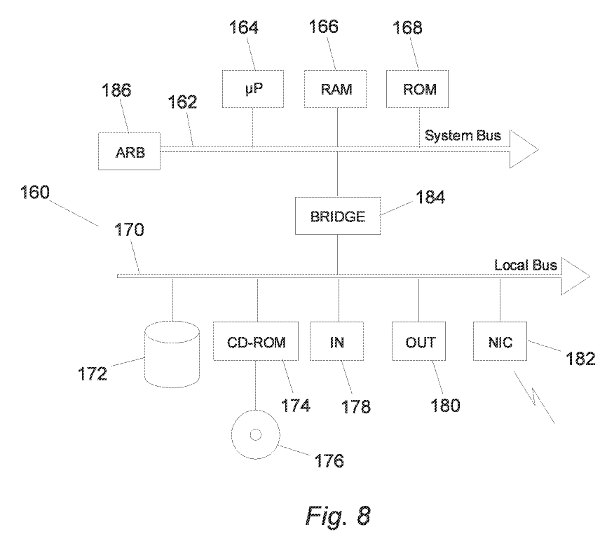

A computer 160 that may be used in implementing the present invention has a generic structure shown in FIG. 8. The computer 160 includes several units that are connected in parallel to a system bus 162. In detail, one or more microprocessors 164 control operation of the computer 160; a RAM 166 is directly used as a working memory by the microprocessors 164, and a ROM 168 stores basic code for a bootstrap of the computer 160. Peripheral units are clustered around a local bus 170 (by means of respective interfaces). Particularly, a mass memory consists of a hard-disk 172 and a drive 176 for reading CD-ROMs 174. Moreover, the computer 160 includes input devices 178 (for example, a keyboard and a mouse), and output devices 180 (for example, a monitor and a printer). A network interface card (NIC) 182 is used to connect the computer 160 to the network. A bridge unit 184 interfaces the system bus 162 with the local bus 170. Each microprocessor 164 and the bridge unit 184 can operate as master agents requesting an access to the system bus 162 for transmitting information. An arbiter 186 manages the granting of the access with mutual exclusion to the system bus 162 configuration.

As discussed above, the invention allows the functionality of a collaboration system to be extended for a user so that the user can be contacted, or at least notified of incoming messages, when away from their own personal computer, but near another computer. As previously noted, an alternative may be to merely communicate the user's current location to other users interested in collaborating. This alternative extends the status options in a collaboration system, which are presently limited to Available/Away/In a Meeting or variants. In accordance with the invention, when the user moves away from their own computer to somewhere within range of another computer, the user's availability can be indicated through a status report such as “Remotely available”. Optionally, the status report can include the user's current “remote” location.

Modifications and alterations may be made to the above without departing from the scope of the invention.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A computer-implemented method for enhancing message collaboration by users of a computer messaging collaboration system, wherein said system includes client devices and one or more servers, said method comprising:
storing in computer memory one or more user profiles, each said user profile identifying a user profile owner and specifying at least one mobile communications device associated to the owner;
receiving a report of a mobile communication device detected in proximity to a client device;
using the identity of said mobile communication device to determine whether a stored user profile exists specifying said mobile communications device; and
responsive to a determination that a stored user profile exists specifying said mobile communications device,
retrieving said user profile, and
performing a predetermined action in accordance with the retrieved user profile.

2. A computer-implemented method according to claim 1 further comprising, responsive to a determination that no stored user profile exists specifying said mobile communications device, disregarding the proximity of said mobile communication device to said client device.

3. A computer-implemented method according to claim 2 wherein performing a predetermined action in accordance with the retrieved user profile further comprises redirecting messages originally addressed to a client device already associated to the user profile owner to the client device detected as being in the proximity of the mobile communications device.

4. A computer-implemented method according to claim 2 wherein performing a predetermined action in accordance with the retrieved user profile further comprises selecting an action from a set of actions comprising:
redirecting messages originally addressed to a client device already associated to the user profile owner to the client device detected as being in the proximity of the mobile communications device;
sending notices of messages addressed to a client device already associated to the user profile owner to the client device detected as being in the proximity of the mobile communications device; and
sending a notice to the sender of the message addressed to the client device already associated to the user profile owner, said notice comprising a statement that the mobile device associated to the user profile owner has been detected in the proximity of said at least one client device.

5. A computer-implemented method according to claim 4 wherein each stored user profile further comprises a specification of one or more client devices that are authorized to receive messages originally directed to the client device previously associated to the user profile owner, and a specification of one or more client devices that are authorized to receive notices of messages directed to the client device previously associated to the user profile owner.

6. A computer-implemented method according to claim 5 wherein each stored profile further comprises a security-related requirement that must be satisfied before a predetermined action will be authorized.

7. A computer-implemented method according to claim 6 wherein said security-related requirement that must be satisfied further comprises the receipt of a handshake operation performed by the user of the detected mobile communications device, said handshake operation being performed using the detected mobile communications device.

8. A computer program product for enhancing message collaboration by users of a computer messaging collaboration system, said computer program product including a computer usable medium having computer usable program code embodied therewith, said computer usable program code comprising:
computer usable program code configured to store in computer memory one or more user profiles, each said user profile identifying a user profile owner and specifying at least one mobile communications device associated to the owner;
computer usable program code configured to receive a report of the detection of the proximity of a mobile communication device to a client device;
computer usable program code configured to use the identity of said mobile communication device to determine whether a stored user profile exists specifying the detected mobile communications device; and
computer usable program code configured, responsive to a determination that a stored user profile exists specifying the detected mobile communications device,
to retrieve said user profile, and
to perform a predetermined action in accordance with the retrieved user profile.

9. A computer program product according to claim 8 further comprising computer usable program code configured, responsive to a determination that no stored user profile exists specifying the detected mobile communications device, to disregard the proximity of said mobile communication device to said client device.

10. A computer program product according to claim 9 wherein said computer usable program code configured to perform a predetermined action in accordance with the retrieved user profile further comprises computer usable program code configured to redirect messages originally addressed to a client device already associated to the user profile owner to the client device detected as being in the proximity of the mobile communications device.

11. A computer program product according to claim 9 wherein said computer usable program code configured to perform a predetermined action in accordance with the retrieved user profile further comprises computer usable program code configured to select computer usable program code from a set of code comprising:
computer usable program code configured to redirect messages originally addressed to a client device already associated to the user profile owner to the client device detected as being in the proximity of the mobile communications device;
computer usable program code configured to send notices of messages addressed to a client device already associated to the user profile owner to the client device detected as being in the proximity of the mobile communications device; and
computer usable program code configured to send a notice to the sender of the message addressed to the client device already associated to the user profile owner, said notice comprising a statement that the mobile device associated to the user profile owner has been detected in the proximity of said at least one client device.

12. A computer program product according to claim 11 wherein each stored user profile further comprises a specification of one or more client devices that are authorized to receive messages originally directed to the client device previously associated to the user profile owner, a specification of one or more client devices that are authorized to receive notices of messages directed to the client device previously associated to the user profile owner.

13. A computer program product according to claim 12 wherein each stored profile further comprises a security-related requirement that must be satisfied before a predetermined action will be authorized.

14. A computer program product according to claim 13 wherein said security-related requirement that must be satisfied further comprises the receipt of a handshake operation performed by the user of the detected mobile communications device, said handshake operation being performed using the detected mobile communications device.

15. An enhanced message collaboration system comprising:
a plurality of client devices;
at least one server device;
system memory for storing one or more user profiles, each said user profile identifying a user profile owner and specifying at least one mobile communications device associated to the owner;
a receiver for receiving a mobile communications device detector report of detection of the proximity of a mobile communications device to a client device;
a search module for, using the identity of said mobile communication device determining whether a user profile exists in system memory specifying the detected mobile communications device; and
a control module for, responsive to a determination that a stored user profile exists specifying the detected mobile communications device,
retrieving said user profile, and
performing a predetermined action in accordance with the retrieved user profile.

16. An enhanced message collaboration system according to claim 15 further comprising control logic for, responsive to a determination that no stored user profile exists specifying the detected mobile communications device, disregarding the proximity of said mobile communication device to said client device.

17. An enhanced message collaboration system according to claim 16, wherein said control module for performing a predetermined action in accordance with the retrieved user profile further comprises control logic for redirecting messages originally addressed to a client device already associated to the user profile owner to the client device detected as being in the proximity of the mobile communications device.

18. An enhanced message collaboration system according to claim 16, wherein said control module for performing a predetermined action in accordance with the retrieved user profile further comprises control logic for selecting an action from a set of actions comprising:
redirecting messages originally addressed to a client device already associated to the user profile owner to the client device detected as being in the proximity of the mobile communications device;
sending notices of messages addressed to a client device already associated to the user profile owner to the client device detected as being in the proximity of the mobile communications device; and
sending a notice to the sender of the message addressed to the client device already associated to the user profile owner, said notice comprising a statement that the mobile device associated to the user profile owner has been detected in the proximity of said at least one client device.

19. An enhanced message collaboration system according to claim 18, wherein each stored user profile further comprises a specification of one or more client devices that are authorized to receive messages originally directed to the client device previously associated to the user profile owner, a specification of one or more client devices that are authorized to receive notices of messages directed to the client device previously associated to the user profile owner.

20. A computer-implemented method for enhancing message collaboration by users of a computer messaging collaboration system, wherein said system includes client devices and one or more servers, said method comprising:
storing in computer memory one or more user profiles, each said user profile identifying a user profile owner and specifying at least one mobile communications device associated to the owner;
receiving a report of a detection of the proximity of a mobile communication device to a client device;
using the identity of said mobile communication device to determine whether a stored user profile exists specifying the detected mobile communications device;
responsive to a determination that no stored user profile exists specifying the detected mobile communications device, disregarding the proximity of said mobile communications device to said client device;
responsive to a determination that a stored user profile exists specifying the detected mobile communications device,
retrieving said user profile,
determining whether the client device to which the mobile communication device is proximate is identified in the retrieved user profile as supporting enhanced message collaboration,
in response to a determination that the client device is identified as supporting enhanced message collaboration,
selecting an action associated with the client device from a set of actions comprising
redirecting messages originally addressed to a client device already associated to the user profile owner to the client device to which the mobile communication device is proximate,
sending notices of messages addressed to a client device already associated to the user profile owner to the client device to which the mobile communication device is proximate, and
sending a notice to the sender of the message addressed to the client device already associated to the user profile owner, said notice comprising a statement that the mobile device associated to the user profile owner is detected in proximity to the client device identified as supporting enhanced message collaboration.
